(19) United States
(12) Patent Application Publication
(10) Pub. No.: US 2014/0012608 A1
(43) Pub. Date: Jan. 9, 2014

(54) Creation, Discovery and Consumption of Group Experiences

(71) Applicants: Jared B. Hecht, New York, NY (US); Steven William Martocci, New York, NY (US)

(72) Inventors: Jared B. Hecht, New York, NY (US); Steven William Martocci, New York, NY (US)

(21) Appl. No.: 13/544,560

(22) Filed: Jul. 9, 2012

(51) Int. Cl. G06Q 10/02

(52) U.S. Cl. 705/5

(57) ABSTRACT

Various embodiments provide a self-service tool to facilitate creation, discovery, and consumption of group experiences. Using the self-service tool, an individual can plan a particular experience for their group at a “one-stop” location. Specifically, an individual planning such an experience can create the experience and invite group members so that the group members can discover the experience and learn more about the planned experience. Further, in at least some embodiments, financial arrangements can be made using the self-service tool in a manner that enables each group member to pay their portion of the expenses for the experience.

### BACKGROUND

One of the problems that people face when they want to get together as a group is that of planning a particular experience, whether it be purchasing a product or service. Often times, an individual planning a particular experience individually contacts each member of a relevant group in order to organize the experience. For example, if an individual wishes to organize a group for a particular concert, they often times individually contact each member of the group to ascertain who can come to the concert. Then, the individual may purchase tickets and make other arrangements, such as planning dinner activities and after-concert activities. This places a number of burdens on the individual planning such an experience. For example, the individual planning the experience can typically spend a good deal of time contacting each individual of the group. Further, the individual planning the experience may have to front the money for the cost of the tickets as well as other costs associated with the experience. Further, once an experience has been planned, communication amongst the group members typically takes place individually, on a one-to-one basis.

### SUMMARY

This Summary is provided to introduce a selection of concepts in a simplified form that are further described below in the Detailed Description. This Summary is not intended to identify key features or essential features of the claimed subject matter.

Various embodiments provide a self-service tool to facilitate creation, discovery, and consumption of group experiences. Using the self-service tool, an individual can plan a particular experience for their group at a “one-stop” location. Specifically, an individual planning such an experience can create the experience and invite group members so that the group members can discover the experience and learn more about the planned experience. Further, in at least some embodiments, financial arrangements can be made using the self-service tool in a manner that enables each group member to pay their portion of the expenses for the experience.

Further, in at least some embodiments, when the experience is planned and the group is finalized, a dedicated chat group can be formed for the finalized group to enable the group to communicate with each other.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 illustrates a group experience module in accordance with one or more embodiments.

FIG. 3 illustrates an example system in accordance with one or more embodiments.

FIG. 4 illustrates a user interface in accordance with one or more embodiments.

FIG. 5 illustrates a user interface in accordance with one or more embodiments.

FIG. 6 illustrates a user interface in accordance with one or more embodiments.

FIG. 7 illustrates a user interface in accordance with one or more embodiments.

FIG. 8 illustrates a user interface in accordance with one or more embodiments.

FIG. 9 illustrates a user interface in accordance with one or more embodiments.

FIG. 10 illustrates a client device in accordance with one or more embodiments.

FIG. 11 illustrates a client device in accordance with one or more embodiments.

FIG. 12 illustrates a client device in accordance with one or more embodiments.

FIG. 13 is a flow diagram that describes steps in a method in accordance with one or more embodiments.

FIG. 14 illustrates an example system that includes the computing device as described with reference to FIG. 1.

FIG. 15 illustrates various components of an example device that can be implemented as any type of computing device as described herein.

### DETAILED DESCRIPTION

Overview

Various embodiments provide a self-service tool to facilitate creation, discovery, and consumption of group experiences. Using the self-service tool, an individual can plan a particular experience for their group at a “one-stop” location. Specifically, an individual planning such an experience can create the experience and invite group members, e.g., by e-mail, social networking site, and the like, so that the group members can discover the experience and learn more about the planned experience. Further, in at least some embodiments, financial arrangements can be made using the self-service tool in a manner that enables each group member to pay their portion of the expenses for the experience. Thus, each member of the group can individually pay their own expenses.

Further, in at least some embodiments, when the experience is planned and the group is finalized, a dedicated chat group can be formed for the finalized group to enable the group to communicate with each other. This can facilitate intra-group communication about details of the planned experience, as well as other related or unrelated details.

Thus, the various embodiments can enable users who prefer doing activities with groups of friends to easily and seamlessly plan such activities, communicate quickly and efficiently with one another, and individually pay their fair share of the expenses for a group experience.

In the sections that follow, a section entitled “Example Environment” describes an example environment in which various embodiments can be implemented. Following this, a section entitled “Example Embodiments” describes various embodiments that can be utilized. Next, a section entitled “Implementation Example” describes an implementation in accordance with one or more embodiments. Next, a section entitled “Example Method” describes an example method in accordance with one or more embodiments. Last, a section entitled “Example System and Device” describes an example system and device that can be utilized to implement the described embodiments.

Consider now a discussion of an example environment in which the various embodiments can be implemented.

Example Environment

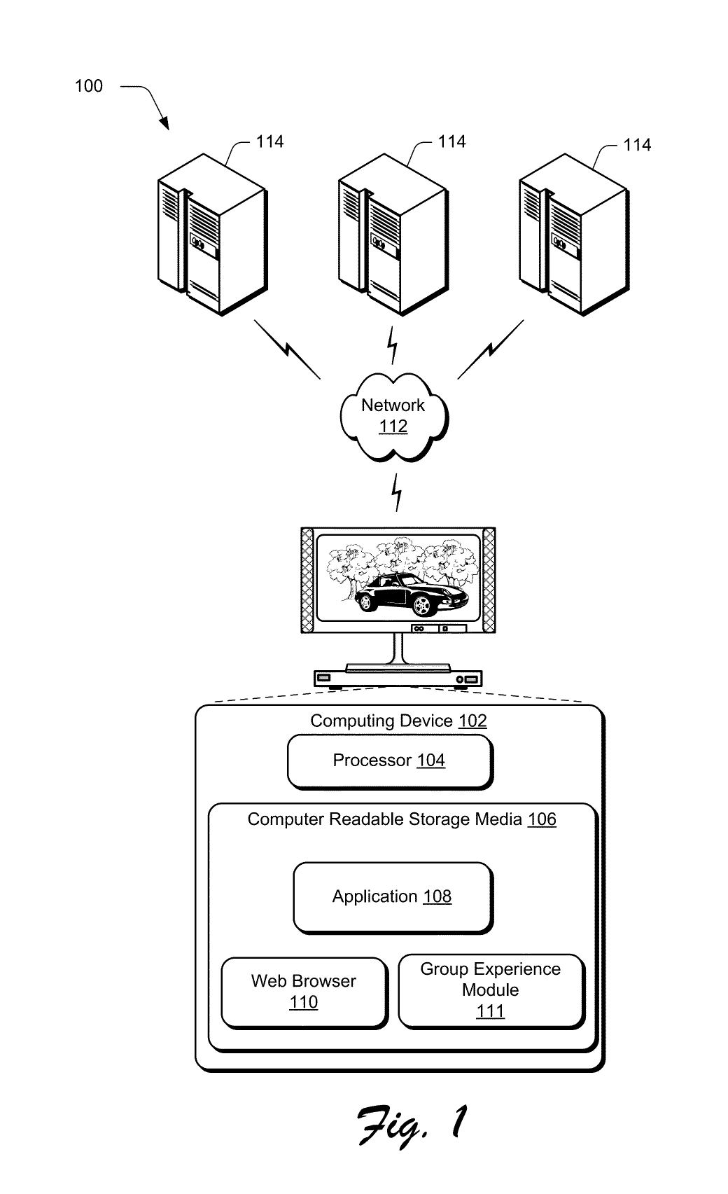

FIG. 1 illustrates an operating environment in accordance with one or more embodiments, generally at 100. Environment 100 includes a computing device 102 in the form of a local client machine having one or more processors 104, one or more computer-readable storage media 106, one or more application 108 that reside on the computer-readable storage media and which are executable by the processor 104. Computing device 102 also includes a web browser 110 and a group experience module 111. The group experience module 111 can be included or integrated as part of the web browser 110, or can be a stand-alone module that serves as a platform that can provide the group experience functionality described below.

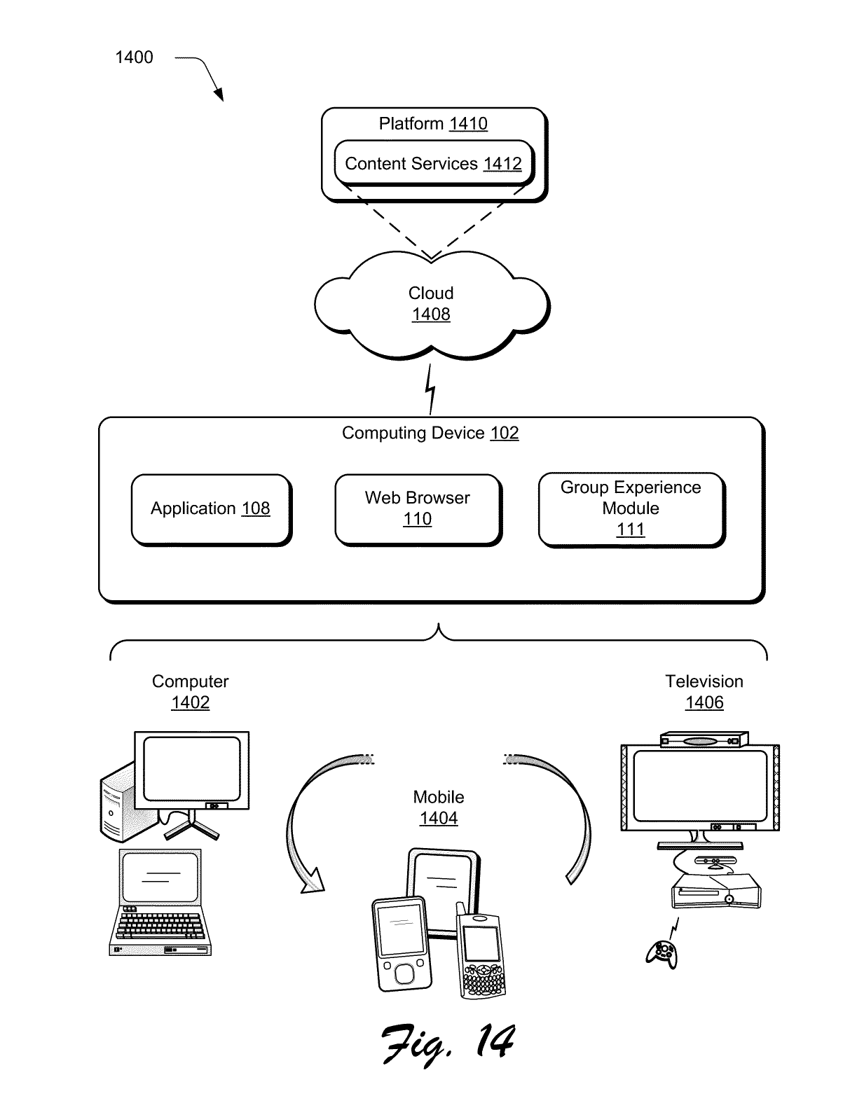

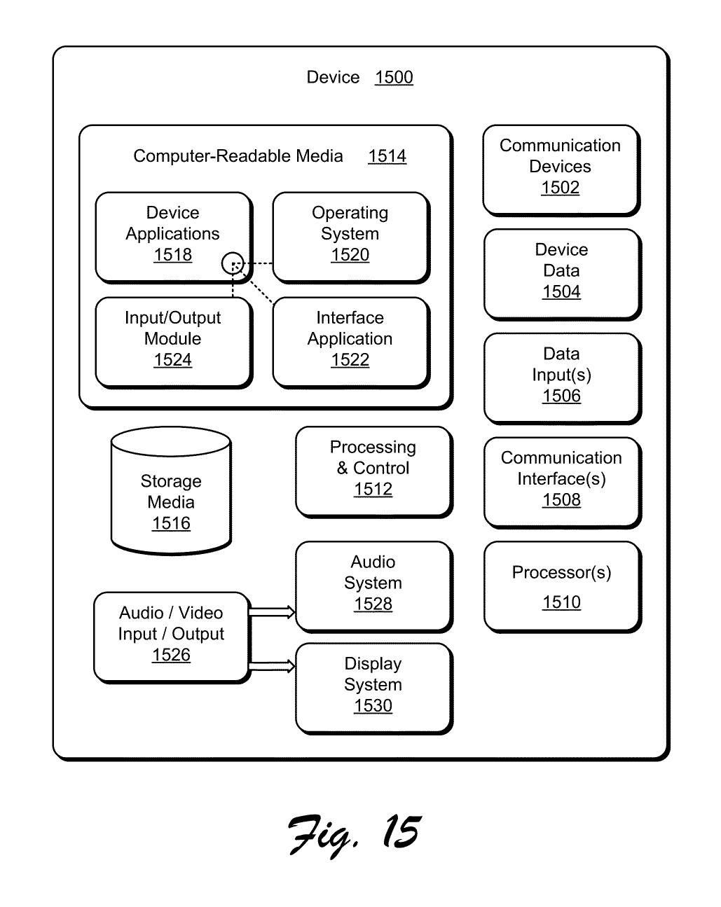

Computing device 102 can be embodied as any suitable computing device such as, by way of example and not limitation, a desktop computer, a portable computer, a handheld computer such as a personal digital assistant (PDA), mobile phone, television, tablet computer, and the like. Varieties of different examples of a computing device 102 are shown and described below in FIGS. 14 and 15.

Application 108 can include any suitable type of application including, by way of example and not limitation, instant message applications, social network applications, voice-over-Internet Protocol applications, and the like. The web browser and/or group experience module 111 are configured to navigate via the network 112. Although the network 112 is illustrated as the Internet, the network may assume a wide variety of configurations. For example, the network 112 may include a wide area network (WAN), a local area network (LAN), a wireless network, a public telephone network, an intranet, and so on. Further, although a single network 112 is shown, the network 112 may be configured to include multiple networks.

The browser may be configured to navigate via the network 112 to interact with content available from one or more web servers 114 as well as communicate data to the one or more web servers 114, e.g., perform downloads and uploads. The web servers 114 may be configured to provide one or more services that are accessible via the network 112. Examples of such services include email, web pages, photo sharing sites, social networks, content sharing services, media streaming services, and so on. In various embodiments, Web servers 114 can provide a service that enables experiences to be created, discovered, and consumed as described below.

One or more of the application 108 may also be configured to access the network 112, e.g., directly themselves and/or through the browser or group experience module. For example, one or more of the application 108 may be configured to communicate messages, such as email, instant messages, and so on. In additional examples, an application 108, for instance, may be configured to access a social network, obtain weather updates, interact with a bookstore service implemented by one or more of the web servers 114, support word processing, provide spreadsheet functionality, support creation and output of presentations, and so on.

Thus, application 108 may also be configured for a variety of functionality that may involve direct or indirect network 112 access. For instance, the application 108 may include configuration settings and other data that may be leveraged locally by the application 108 as well as synchronized with applications that are executed on another computing device. In this way, these settings may be shared by the devices. A variety of other instances are also contemplated. Thus, the computing device 102 may interact with content in a variety of ways from a variety of different sources.

In operation, group experience module 111 provides a self-service tool to facilitate creation, discovery, and consumption of group experiences. Using the self-service tool, an individual can plan a particular experience for their group at a “one-stop” location. Specifically, an individual planning such an experience can create the experience and invite group members, e.g., by e-mail, social networking site, and the like, so that the group members can discover the experience and learn more about the planned experience. Further, in at least some embodiments, financial arrangements can be made using the self-service tool in a manner that enables each group member to pay their portion of the expenses for the experience. Thus, each member of the group can individually pay their own expenses.

Further, in at least some embodiments, when the experience is planned and the group is finalized, a dedicated chat group can be formed by the group experience module 111 for the finalized group to enable the group to communicate with each other. This can facilitate intra-group communication about details of the planned experience, as well as other related or unrelated details.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware or virtual machines of the computing device 102 to perform operations, e.g., processors, functional blocks, and so on. For example, the computing device 102 may include a computer-readable medium that may be configured to maintain instructions that cause the computing device, and more particularly the operating system and associated hardware of the computing device 102 to perform operations. Thus, the instructions function to configure the operating system and associated hardware to perform the operations and in this way result in transformation of the operating system and associated hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having described an example environment in which the techniques described herein may operate, consider now a discussion of some example embodiments that can utilize the principles described herein.

Example Embodiments

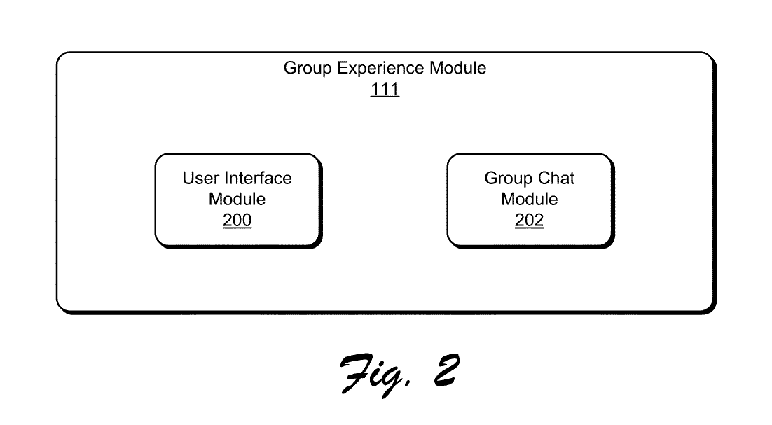

FIG. 2 illustrates group experience module 111 in more detail, in accordance with one or more embodiments. Group experience module 111 includes a user interface module 200 and includes or otherwise makes use of a group chat module 202.

User interface module 200 provides a user interface through which a user can create, discover, and/or consume group experiences. The group experiences can be those that are pre-defined by a particular service, such as a service provided by server 114 (FIG. 1). Alternately or additionally, group experiences can be planned and initially defined, from the beginning, by an individual user.

With respect to pre-defined group experiences, consider the following. In one or more embodiments, merchants and vendors of products and/or services can register with a particular service and offer individual bundles of group experiences that can be consumed by various groups. For example, concert vendors may bundle together a group experience for a particular concert and include, with the group experience, various features such as tickets (including numbers of tickets), dinner, drinks, and the like. The vendor can set their own prices and define their offerings.

With respect to experiences that can be planned, from the beginning, by an individual user, consider the following. In some embodiments, individual vendors or merchants can register with a particular service and broadly make available a range of different offerings that can be selected by a particular user. In this instance, the user can mix and match the various service offerings that are provided by the vendor or merchant. In this manner, the experience is defined by the user and is not pre-defined by the service. Alternately or additionally, in some embodiments, a user can create a plan page for inventory that the user has found on their own, outside inventory that is offered by registered vendors or merchants. For example, the user might have located a ski house in Vermont that he or she found on a separate web page. Using the techniques described herein, the user can create a plan page similar to the pages described in this document and invite friends to the user-defined experience.

Once a group experience has been planned, whether through a pre-defined group experience or a user-defined group experience, the user can invite their friends to participate in the group experience using a user interface provided by user interface module 200. One example of a user interface provided by user interface module 200 is provided below.

Group chat module 202 enables individual users of a particular defined group to communicate with one another. That is, in at least some embodiments, once a group experience has been planned, a chat group can be formed by the group chat module 202 and dedicated to the individual members of the group. Using the chat group, members of the group can communicate with one another about the group experience.

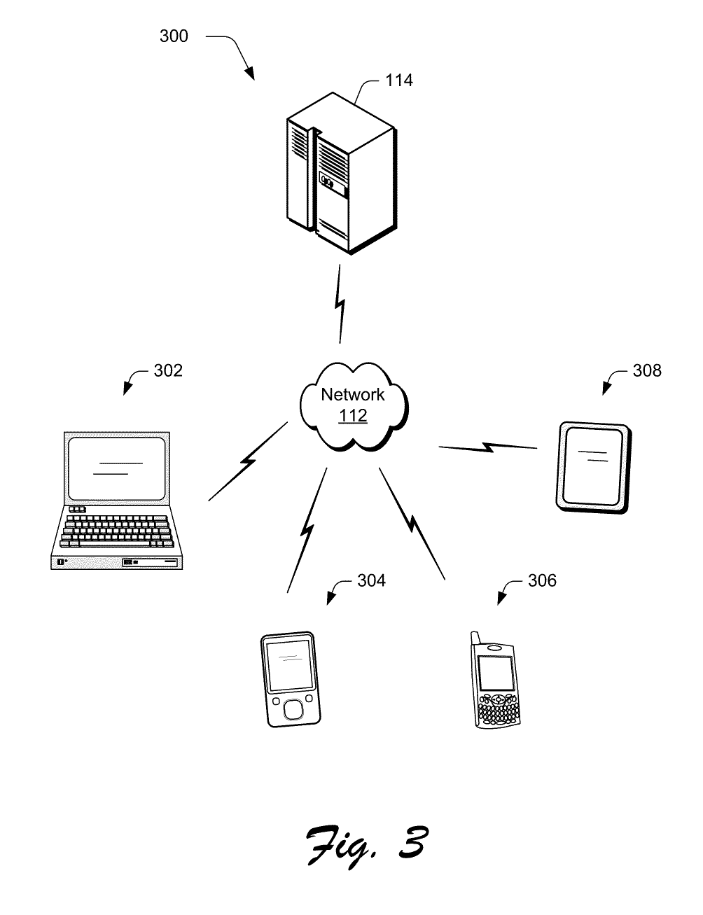

FIG. 3 illustrates an example system 300 that includes server 114, network 112, and various user or client devices 302, 304, 306, and 308. In this example, assume that the user of the client device 302 is the planner or organizer of the group experience. Each of the client devices 302-308 can include a group experience module to enable them to create, discover, or consume a group experience. Once the user of client device 302 has planned the group experience, they can invite their friends by sending a URL, dedicated to the specific group experience, to each of the users of client devices 304, 306, 308. By clicking on or otherwise selecting the URL, each invited user can discover the group experience that has been planned and make a decision as to whether participate in the experience or not.

Having considered an example system in accordance with one or more embodiments, consider now an implementation example. The implementation example about to be described constitutes but an example only. Accordingly, the implementation example is not to be construed as limiting applicability of the claimed subject matter.

Implementation Example

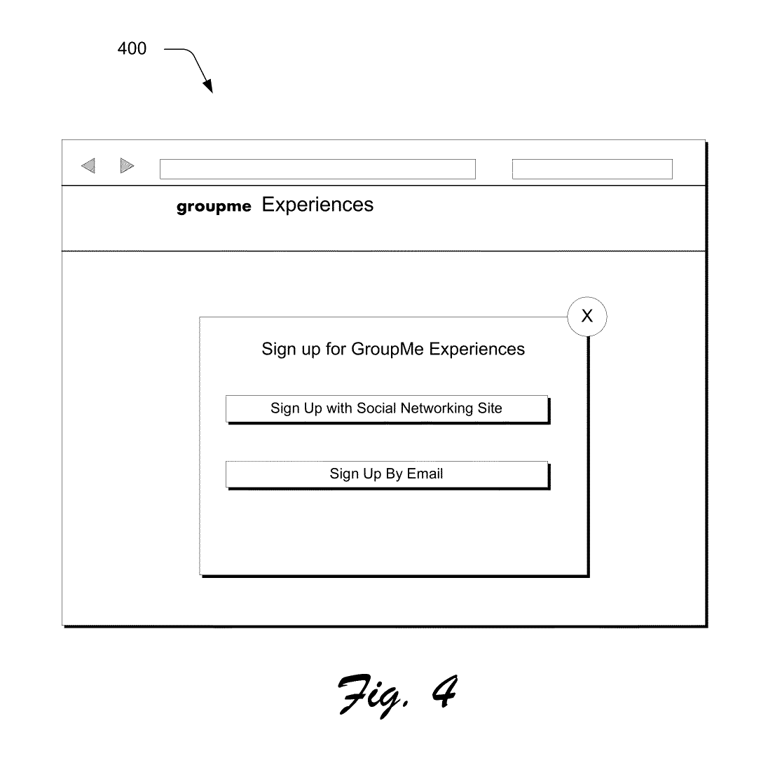

FIG. 4 illustrates an example user interface in accordance with one or more embodiments, generally at 400. In this example, the user interface constitutes a so-called “landing page” which provides information about the service offering group experiences. The landing page can include an “About Us” link that provides additional information about the service, as well as other information such as, by way of example and not limitation, a multimedia presentation and a registration prompt. In this example, assume that the user who is planning the group experience has not yet signed up for the service. By clicking on a particular menu button, the user can sign up for the service. In this particular example, the user can sign up for the service using a social networking site or, alternately, by e-mail.

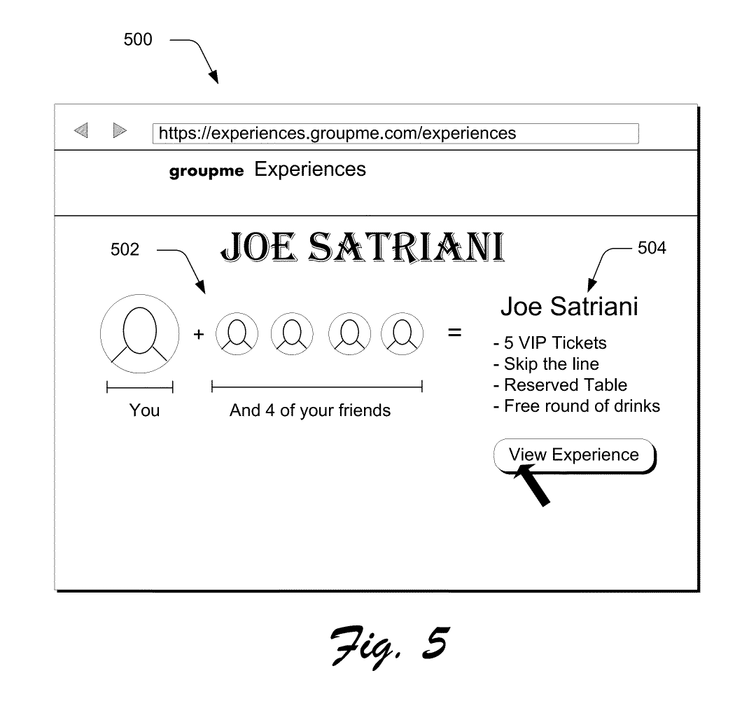

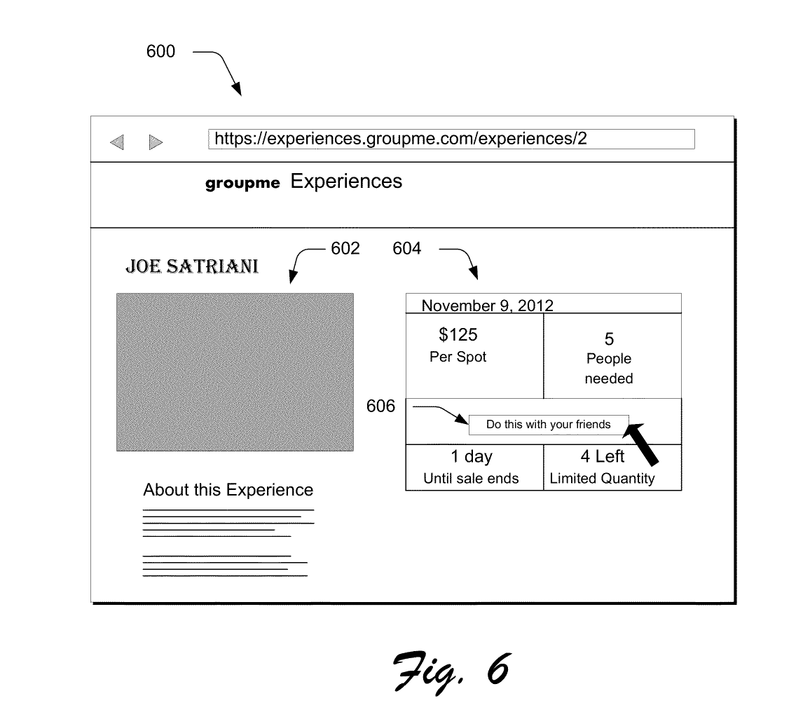

Once the user is signed up for the service, the user can begin to browse through multiple offers and click through to learn more about the offers. As an example, consider FIG. 5. There, a user interface in accordance with one or more embodiments is shown generally at 500. In this example, the user has selected an experience in the form of a concert. A visualization 502 is provided and represents the user and four potential friends whom they can invite for the experience. In addition, information is presented at 504 and describes the various offerings associated with this experience. In addition, a user instrumentality in the form of a “View Experience” button is provided so that the user can learn more about this particular experience. By clicking on this button, the user can be provided with more information about the experience. As an example, consider FIG. 6.

There, a user interface in accordance with one or more embodiments is shown generally at 600. In this example, the user interface can include information about the experience such as, by way of example and not limitation, images and/or videos 602. In addition, a description of the experience, i.e. “About this Experience” can describe in greater detail what the experience entails.

Further, in one or more embodiments, additional information, shown generally at 604, can be provided to assist the user in ascertaining whether to book the experience and invite their friends. In this particular example, information 604 includes a price per spot (i.e., price for each user), the number of people defined for this experience, and other information. In addition, a user instrumentality 606 is provided to enable the user organizing experience to invite their friends.

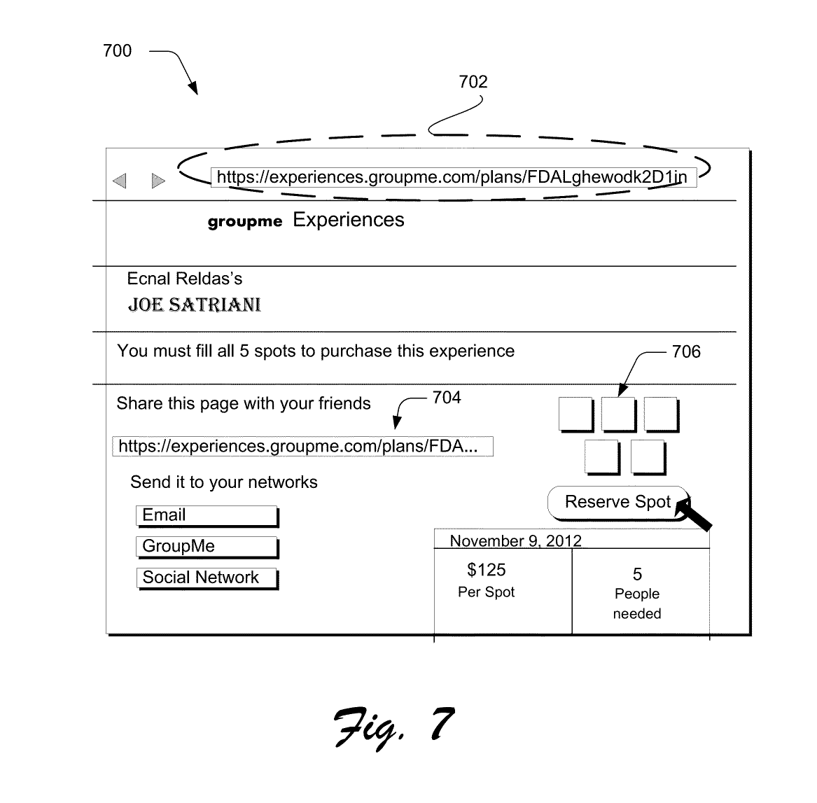

Assume now that the user has decided to move forward in booking the experience. This can be done, for example, by clicking on user instrumentality 606. When the user moves forward in booking the experience, they can be navigated through a booking experience. As an example, consider FIG. 7.

There, a user interface in accordance with one or more embodiments is shown generally at 700. In this example, a so-called “plan” has been personalized for the user and the prospective group members. This personalized plan is exemplified through the use of a URL 702 that is dedicated to this particular instance of the experience being booked by the user. The URL 702 will serve as the basis by which the user's friends can be invited to the experience, as will become apparent below.

In the illustrated and described embodiment, a portion of the user interface, shown generally at 704, enables the user to share the page with their friends for purposes of enabling their friends to accept the user's invitation. In this example, a number of different mechanisms can be utilized to enable the user to share the page with their friends. For example, the user can share the page with their friends by way of e-mail, a platform communication (i.e. “GroupMe”), or one or more social networks. When the page is shared with the user's friends, the associated URL is sent to each of their friends.

The user interface also includes a portion, shown generally at 706, that includes one or more icons or avatars that can be associated with each user. In this way, users who are invited to an experience can see the other users who are also invitees who have reserved spots by entering payment information. This can facilitate an invitee's decision on whether to reserve a spot in the experience.

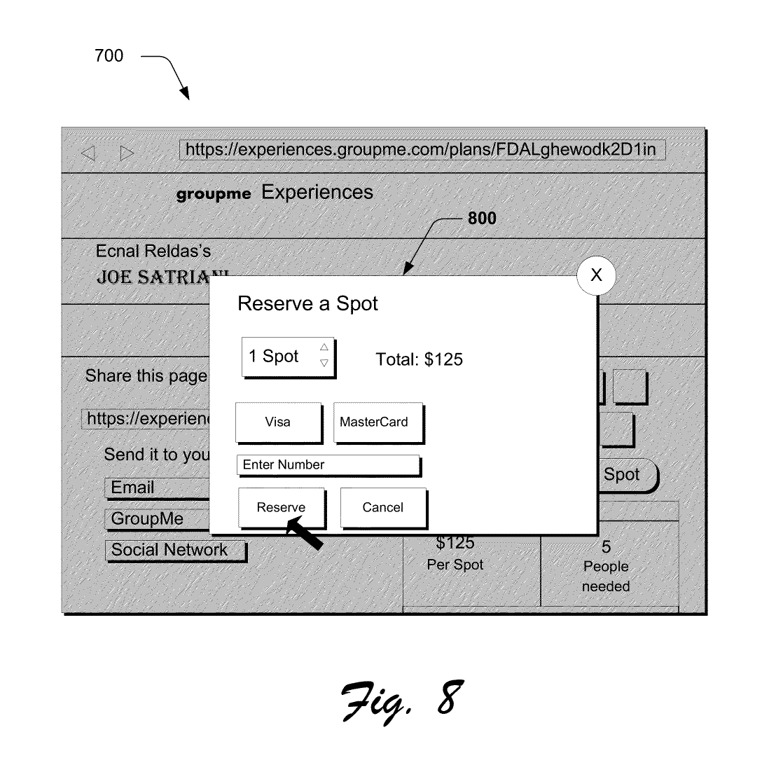

Assume, in this example, that the particular user (in this case, the user creating the experience) wishes to reserve a spot as by, for example, clicking on the “Reserve Spot” button. In this case, the user can be presented with a user interface that enables them to reserve and pay for a spot in the experience. As an example, consider FIG. 8.

There, user interface 700 is shown together with a dialog box 800 that enables the user to reserve a spot. The dialog box can be configured to enable the user to reserve multiple spots. In addition, the price per spot is shown as well as a number of different payment options. In this particular instance, user interface buttons can enable the user to select a particular credit card to pay for their spot. Once the user enters their credit card number, they can click a “Reserve” button to reserve their spot. In one or more embodiments, reserving a spot represents a placeholder in which the user is not billed until the full group commits to the experience.

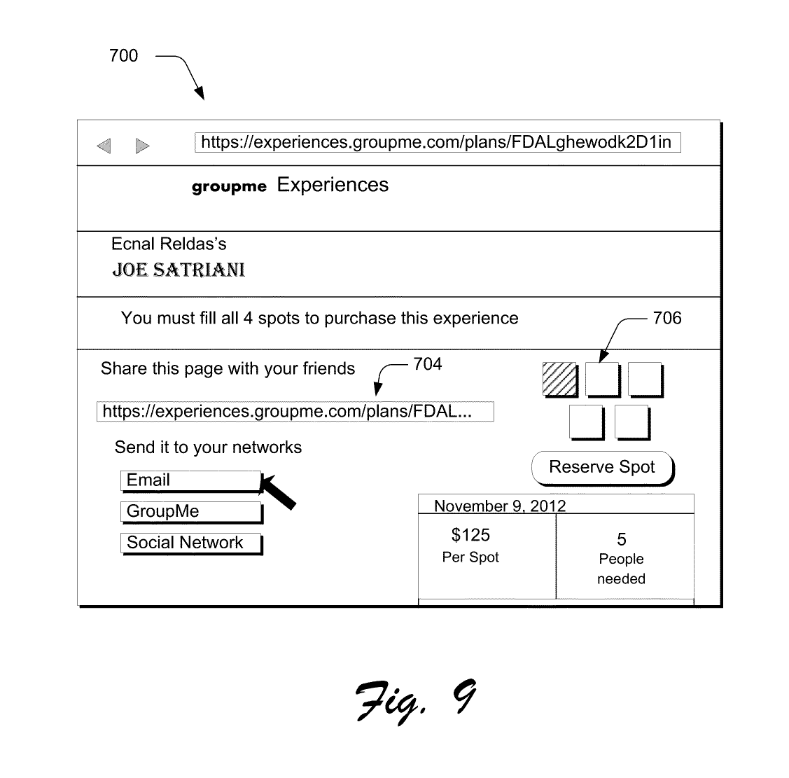

Now that the user booking the experience has reserved their spot, they can invite their friends to the plan. As an example, consider FIG. 9.

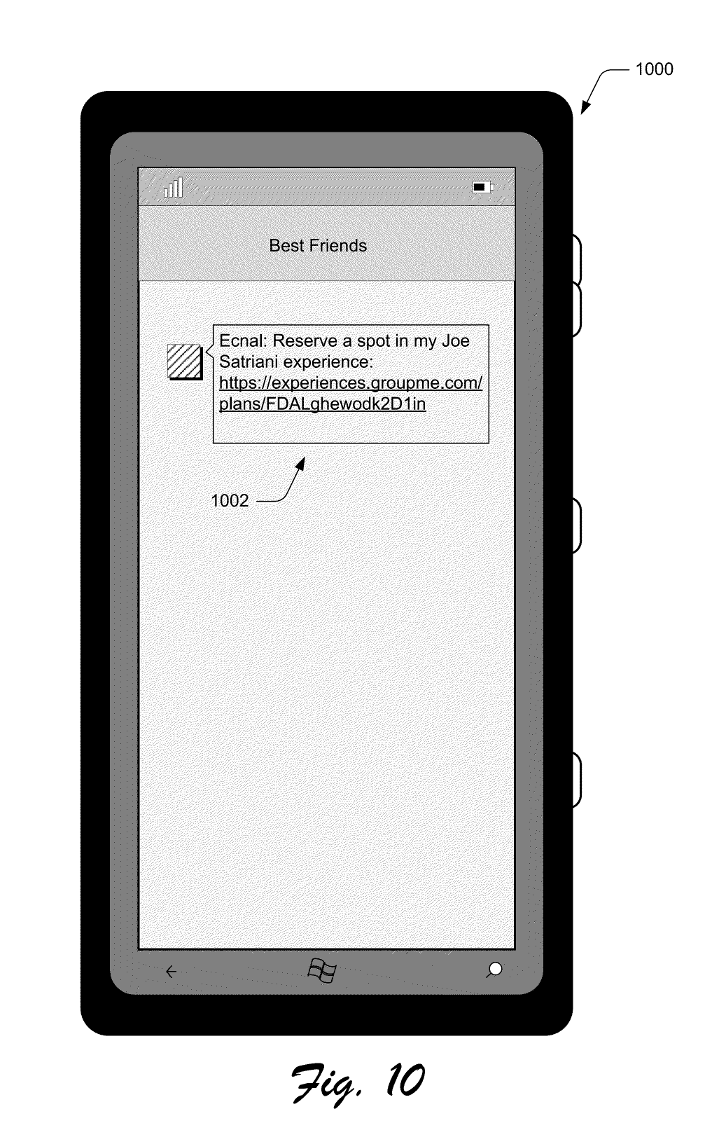

There, user interface 700 is illustrated and the user has clicked on the e-mail button. By doing so, the user can now select from among their contacts or enter an e-mail address of the friends to whom invitations are to be sent. When the invitations are sent, the dedicated URL is sent along with the invitation, as noted above. Notice, in this example, that one of the icons in interface portion 706 is shown as being crosshatched. This represents the image or avatar associated with the user who has already reserved their spot. Now, when the user's friends receive their invitation, by clicking on the dedicated URL, they will be navigated to the webpage and be able to learn about the experience or plan and see who has reserved spots thus far. As an example, consider FIG. 10.

There, the client device of one of the user's friends is shown at 1000. An invitation is shown generally at 1002 and includes the user's icon or avatar along with a message inviting the friend to reserve a spot in the experience booked by the user. In this example, the message includes text and the dedicated URL. By clicking on or otherwise selecting the dedicated URL, the user's friend will be navigated to a page that describes the experience. There, the user's friend can learn more about the experience and make a decision as to whether to reserve a spot.

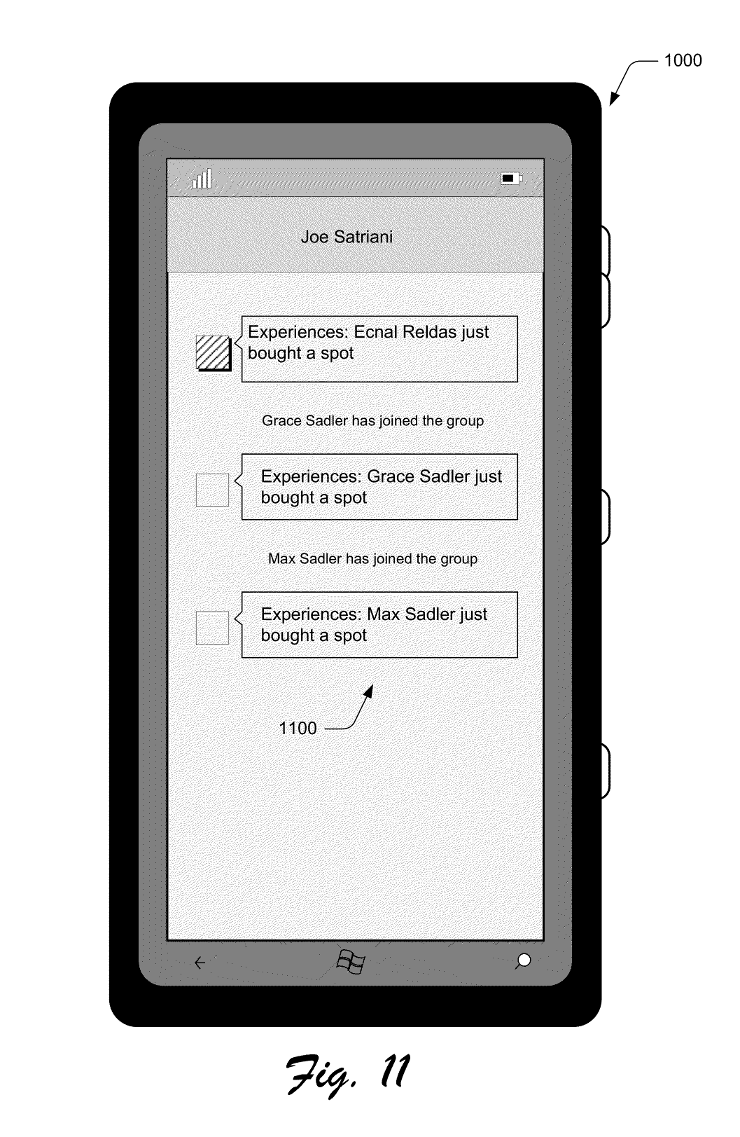

As noted above, in one or more embodiments a dedicated chat group can be automatically formed for members of the group to chat. As an example, consider FIG. 11.

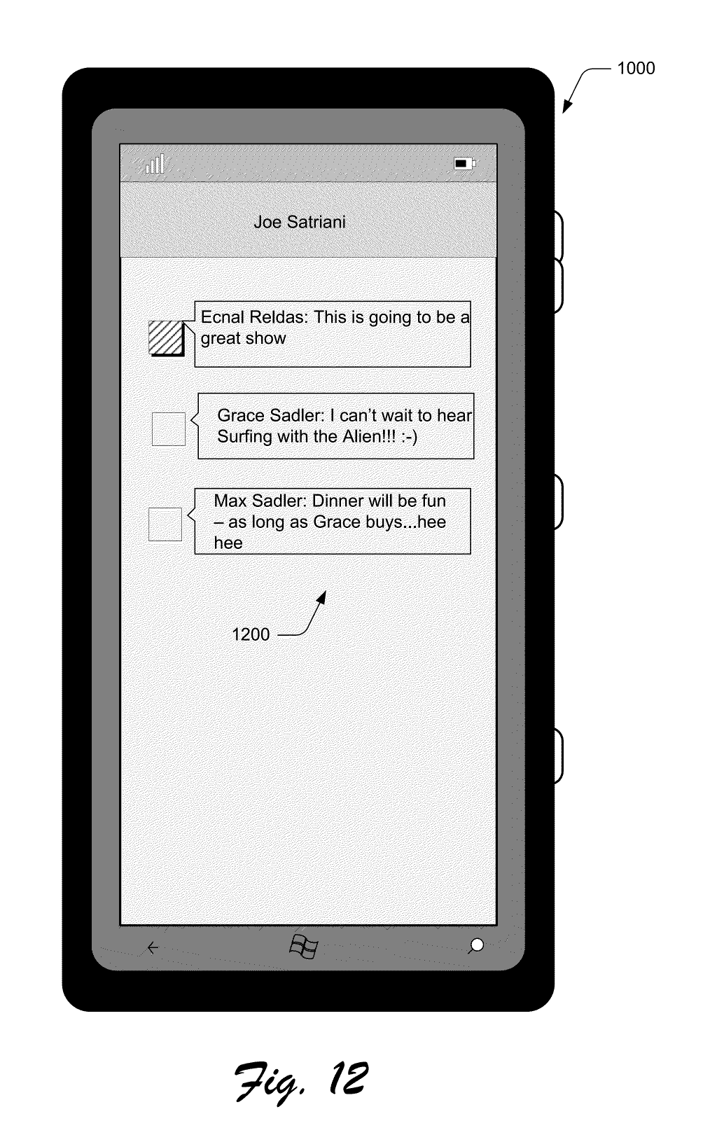

There, client device 1000 is shown and includes a thread 1100 that indicates the individuals who have joined the group. The individuals can now communicate in real-time with each other. Once all of the spots have been filled, each of the members of the group can receive a notification, such as an e-mail confirmation, with redemption instructions. All of the members of the group can now communicate with each other using their chat group. Such is represented in FIG. 12 generally at 1200, where individual members of the group can be seen to be chatting about the booked experience.

In addition to creating, discovering, and consuming an experience, other services can be provided in connection with the experience. For example, in at least some embodiments upselling offers can be made to members of the group to enable them to purchase additional products or services associated with their experience. For example, each of the users may be presented with an advertisement for transportation services to and from the concert.

Example Method

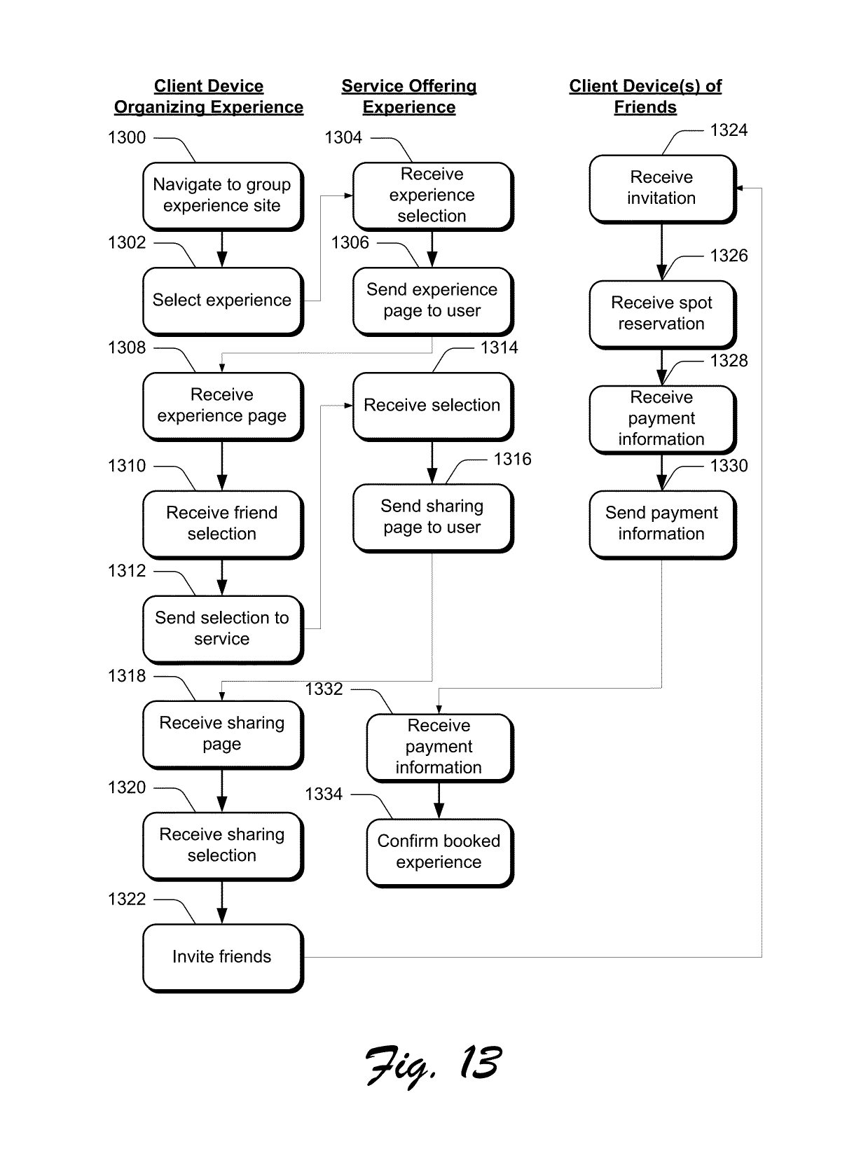

FIG. 13 is a flow diagram that describes steps in a method in accordance with one or more embodiments. The method can be implemented in connection with any suitable hardware, software, firmware, or combination thereof. In the illustrated example, the method is shown as being implemented by three different entities. A first entity entitled “Client Device Organizing Experience” represents the client device of the user creating the experience. A second entity entitled “Service Offering Experience” represents the service that offers the experiences that can be reserved by various users. A third entity entitled “Client Device(s) of Friends” represents the client devices of the friends who are invited to the experience by the user creating the experience.

Step 1300 navigates to a group experience site. A group experience site is typically implemented by a service that can offer a number of different group experiences from which a user can select. These group experiences can be pre-defined experiences or user-defined experiences as noted above. Step 1302 selects a group experience. An example of how this can be done is provided above.

Step 1304 receives, at the service, an experience selection.

Responsive to receiving the experience selection, step 1306 sends an experience page to the user. The experience page can be a webpage that details information about the experience selected by the user. This can effectively enable the user to reserve a spot for the particular experience through their interaction with the page. Step 1308 receives, at the client device organizing the experience, the experience page. Once the experience page is received, the user can reserve a spot and submit payment information to the service. Step 1310 receives a friend selection. This selection indicates that the user wishes to invite friends to the experience. Step 1312 sends the friend selection to the service.

Step 1314 receives, at the service, the selection and responsively, step 1316 sends a sharing page to the user. The sharing page enables the user to share an invitation with one or more friends so that their friends can reserve a spot for the experience.

Step 1318 receives the sharing page and step 1320 receives a sharing selection. The sharing selection enables the user to share an invitation to the experience with one or more of their friends. Accordingly, step 1322 invites the user's friends by sending an invitation to the selected friends. Examples of how this can be done are provided above.

Step 1324 receives the invitation at each of the client devices of the respective friends. Step 1326 receives a spot reservation and step 1328 receives payment information regarding the spot reservation. Step 1330 sends the payment information to the service offering the experience.

Step 1332 receives, at the service offering the experience, the payment information. In one or more embodiments, the payment information can serve as a placeholder until all the members of the group reserve a spot. Once all of the members of the group have reserved a spot, in at least some embodiments, step 1334 confirms the booked experience and charges the individual users in accordance with their submitted payment information.

Having considered an example method in accordance with one or more embodiments, consider now an example system and device that can be utilized to implement the described embodiments.

Example System and Device

FIG. 14 illustrates an example system 1400 that includes the computing device 102 as described with reference to FIG. 1. The example system 1400 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1400, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 1402, mobile 1404, and television 1406 uses. Each of these configurations includes devices that may have generally different constructs and capabilities, and thus the computing device 102 may be configured according to one or more of the different device classes. For instance, the computing device 102 may be implemented as the computer 1402 class of a device that includes a personal computer, desktop computer, a multi-screen computer, laptop computer, netbook, and so on. Each of these different configurations may employ the techniques described herein, as illustrated through inclusion of the application 108, web browser 110 and group experience module 111.

The computing device 102 may also be implemented as the mobile 1404 class of device that includes mobile devices, such as a mobile phone, portable music player, portable gaming device, a tablet computer, a multi-screen computer, and so on. The computing device 102 may also be implemented as the television 1406 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 1408 includes and/or is representative of a platform 1410 for content services 1412. The platform 1410 abstracts underlying functionality of hardware (e.g., servers) and software resources of the cloud 1408. The content services 1412 may include applications and/or data that can be utilized while computer processing is executed on servers that are remote from the computing device 102. Content services 1412 can be provided as a service over the Internet and/or through a subscriber network, such as a cellular or Wi-Fi network.

The platform 1410 may abstract resources and functions to connect the computing device 102 with other computing devices. The platform 1410 may also serve to abstract scaling of resources to provide a corresponding level of scale to encountered demand for the content services 1412 that are implemented via the platform 1410. Accordingly, in an interconnected device embodiment, implementation of functionality described herein may be distributed throughout the system 1400. For example, the functionality may be implemented in part on the computing device 102 as well as via the platform 1410 that abstracts the functionality of the cloud 1408.

FIG. 15 illustrates various components of an example device 1500 that can be implemented as any type of computing device as described with reference to FIGS. 1 and 14 to implement embodiments of the techniques described herein. Device 1500 includes communication devices 1502 that enable wired and/or wireless communication of device data 1504 (e.g., received data, data that is being received, data scheduled for broadcast, data packets of the data, etc.). The device data 1504 or other device content can include configuration settings of the device, media content stored on the device, and/or information associated with a user of the device. Media content stored on device 1500 can include any type of audio, video, and/or image data. Device 1500 includes one or more data inputs 1506 via which any type of data, media content, and/or inputs can be received, such as user-selectable inputs, messages, music, television media content, recorded video content, and any other type of audio, video, and/or image data received from any content and/or data source.

Device 1500 also includes communication interfaces 1508 that can be implemented as any one or more of a serial and/or parallel interface, a wireless interface, any type of network interface, a modem, and as any other type of communication interface. The communication interfaces 1508 provide a connection and/or communication links between device 1500 and a communication network by which other electronic, computing, and communication devices communicate data with device 1500.

Device 1500 includes one or more processors 1510 (e.g., any of microprocessors, controllers, and the like) which process various computer-executable instructions to control the operation of device 1500 and to implement embodiments of the techniques described herein. Alternatively or in addition, device 1500 can be implemented with any one or combination of hardware, firmware, or fixed logic circuitry that is implemented in connection with processing and control circuits which are generally identified at 1512. Although not shown, device 1500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1500 also includes computer-readable media 1514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1500 can also include a mass storage media device 1516.

Computer-readable media 1514 provides data storage mechanisms to store the device data 1504, as well as various device applications 1518 and any other types of information and/or data related to operational aspects of device 1500. For example, an operating system 1520 can be maintained as a computer application with the computer-readable media 1514 and executed on processors 1510. The device applications 1518 can include a device manager (e.g., a control application, software application, signal processing and control module, code that is native to a particular device, a hardware abstraction layer for a particular device, etc.). The device applications 1518 also include any system components or modules to implement embodiments of the techniques described herein. In this example, the device applications 1518 include an interface application 1522 and an input/output module 1524 that are shown as software modules and/or computer applications. The input/output module 1524 is representative of software that is used to provide an interface with a device configured to capture inputs, such as a touchscreen, track pad, camera, microphone, and so on. Alternatively or in addition, the interface application 1522 and the input/output module 1524 can be implemented as hardware, software, firmware, or any combination thereof. Additionally, the input/output module 1524 may be configured to support multiple input devices, such as separate devices to capture visual and audio inputs, respectively.

Device 1500 also includes an audio and/or video input-output system 1526 that provides audio data to an audio system 1528 and/or provides video data to a display system 1530. The audio system 1528 and/or the display system 1530 can include any devices that process, display, and/or otherwise render audio, video, and image data. Video signals and audio signals can be communicated from device 1500 to an audio device and/or to a display device via an RF (radio frequency) link, S-video link, composite video link, component video link, DVI (digital video interface), analog audio connection, or other similar communication link. In an embodiment, the audio system 1528 and/or the display system 1530 are implemented as external components to device 1500. Alternatively, the audio system 1528 and/or the display system 1530 are implemented as integrated components of example device 1500.

### CONCLUSION

Various embodiments provide a self-service tool to facilitate creation, discovery, and consumption of group experiences. Using the self-service tool, an individual can plan a particular experience for their group at a “one-stop” location. Specifically, an individual planning such an experience can create the experience and invite group members so that the group members can discover the experience and learn more about the planned experience. Further, in at least some embodiments, financial arrangements can be made using the self-service tool in a manner that enables each group member to pay their portion of the expenses for the experience.

Further, in at least some embodiments, when the experience is planned and the group is finalized, a dedicated chat group can be formed for the finalized group to enable the group to communicate with each other.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A computer-implemented method comprising:
receiving, at a service that offers group experiences, an experience selection from a user, the experience selection pertaining to a group experience that can be created by the user and shared by way of an invitation amongst one or more friends of the user;
enabling the user to reserve a spot for the group experience;
enabling the user to share an invitation with one or more friends to enable said one or more friends to reserve a spot for the group experience; and
receiving payment information from the user and said one or more friends, the payment information enabling the user and said one or more friends to pay for the group experience.

2. The method of claim 1, wherein the group experience is pre-defined by the service.

3. The method of claim 1, wherein the group experience is defined by the user.

4. The method of claim 1 further comprising forming, by the service, a chat group for the user and said one or more friends.

5. The method of claim 1, wherein said enabling the user to share an invitation comprises sending a URL, dedicated to the group experience, to said one or more friends.

6. The method of claim 1, wherein said enabling the user to reserve a spot is performed, at least in part, by providing information including a price per spot and a number of people defined for the group experience.

7. The method of claim 1, wherein said enabling the user to share an invitation with one or more friends comprises enabling the invitation to be shared using a number of different mechanisms.

8. The method of claim 1, wherein said enabling the user to share an invitation with one or more friends comprises enabling the invitation to be shared using a number of different mechanisms, one of the mechanisms comprising e-mail.

9. The method of claim 1, wherein said enabling the user to share an invitation with one or more friends comprises enabling the invitation to be shared using a number of different mechanisms, one of the mechanisms comprising a social network.

10. The method of claim 1, wherein said enabling the user to share an invitation with one or more friends comprises including icons or avatars associated, respectively, with the user and said one or more friends.

11. One or more computer-readable storage media embodying computer readable instructions, which, when executed, implement a method comprising:
navigating to a group experience site, the group experience site being offered by a service;
receiving a group experience selection, the group experience selection pertaining to a group experience that can be created by a user and shared by way of an invitation amongst one or more friends of the user;
responsive to said receiving, receiving an experience page configured to enable the user to reserve a spot for said group experience and submit payment information for said spot;
inviting said one or more friends to the group experience by causing an invitation to be sent to said one or more friends, said invitation being configured to enable said one or more friends to reserve a spot for the group experience and submit, respectively, payment information to pay for the group experience.

12. The one or more computer-readable storage media of claim 11, wherein the group experience is pre-defined by the service.

13. The one or more computer-readable storage media of claim 11, wherein the group experience is defined by the user.

14. The one or more computer-readable storage media of claim 11, further comprising enabling use of a chat group for the user and said one or more friends.

15. The one or more computer-readable storage media of claim 11, wherein said inviting comprises causing a URL, dedicated to the group experience, to be sent to said one or more friends.

16. The one or more computer-readable storage media of claim 11, wherein said receiving an experience page comprises receiving information including a price per spot and a number of people defined for the group experience.

17. The one or more computer-readable storage media of claim 11, wherein said inviting comprises receiving a selection of one of a plurality of different mechanisms to enable the invitation to be sent to said one or more friends, said different mechanisms comprising, at least, e-mail or a social network.

18. The one or more computer-readable storage media of claim 11, wherein said inviting comprises causing inclusion of, in the invitation, icons or avatars associated, respectively, with the user and said one or more friends.

19. A system comprising:
one or more computer readable storage media;
a user interface embodied on the one or more computer readable storage media and being configured to:
enable a user to browse through multiple offers that pertain to group experiences that can be created by the user and shared by way of an invitation amongst one or more friends of the user;
enable the user to reserve a spot for a group experience and enter payment information for the group experience;
invite said one or more friends to reserve spots for the group experience and enter payment information, respectively, to pay for the group experience; and
display icons or avatars associated, respectively, with the user and said one or more friends.

20. The system of claim 19, wherein the user interface is further configured to:
invite said one or more friends by sending a URL, dedicated to the group experience, to said one or more friends; and
enable the user and said one or more friends to participate in a chat group associated with the group experience.
